(19) United States
(12) Patent Application Publication
(10) Pub. No.: US 2011/0233894 A1
(43) Pub. Date: Sep. 29, 2011

(54) WHEEL GUARD

(75) Inventor: Jack B. Lovley, II, Lake Forest, CA (US)

(73) Assignee: BRAVO SPORTS, Santa Fe Springs, CA (US)

(21) Appl. No.: 12/732,032

(22) Filed: Mar. 25, 2010

(51) Int. Cl. B62J 27/00; B62M 1/00

(52) U.S. Cl. 280/288.4; 280/304.3; 280/87.041

(57) ABSTRACT

A wheel guard insert for use in reducing the axial gap between a wheel and its associated support structure. Generally, the wheel guard comprises a base portion attachable to the support structure between the support structure and the wheel and one or a pair of protrusions extending between the base portion and a contoured surface that substantially matches an axial face contour of the wheel. The base portion and the protrusion may be integrally formed from a plastic material, rubber, or sheet metal. The base portion may also be contoured so that it follows a surface of the support structure. Preferably, the contoured surface is located within 5 mm of the axial face. The base portion may be attached to the support structure with fasteners that engage apertures formed through the base portion that are sized and configured to receive the fastener.

### FIELD OF THE INVENTION

The invention described herein relates generally to a guard for accessible clearances between movable segments. More specifically, the invention described herein relates to a wheel guard insert for non-motorized foot board scooters for use in reducing the axial gap between a wheel of the scooter and its associated support structure.

### BACKGROUND

Non-motorized foot board scooters are known in the art. These scooters generally include a front wheel aligned with a back wheel, with each of the wheels being attached to a frame. The frame generally comprises a flat surface located between the two wheels for the rider to stand on and a steering column rising vertically relative to the front end of the flat surface. The steering column is attached at one end to the front wheel for front wheel steering of the scooter and terminates at the other end in handle bars for the rider to use to steer the scooter. Forward movement of these non-motorized foot board scooters is normally achieved by the rider taking one foot off the flat surface and pushing against the ground with the foot removed from the flat surface to begin forward movement of the scooter.

Because scooters are usually marketed toward children, there are particular safety concerns associated with scooters. Of course, one concern is the safe operation of scooters, which is enhanced through supervision and the use of proper safety gear such as helmets and knee pads. Regarding the design of scooters, there are several areas of concern including durability, brakes, proper warning labels, and pinching hazards. Indeed, the American Society of Standards and Testing (ASTM) has promulgated a standard consumer safety specification directed to non-powered scooters which sets safety requirements for these aspects of scooter design (ASTM F2264). One area of particular interest here is the clearance between the wheel of a scooter and its associated support structure, such as the clearance between the spokes of the front wheel and the arms of the fork. Such clearance has the potential to pinch, crush, and/or trap a child's fingers.

Accordingly, there exists a need to eliminate or reduce such accessible clearances between the wheel and support structures of scooters and other wheeled vehicles.

### SUMMARY

Described herein are various embodiments of a wheel guard insert for use in reducing the axial gap between a wheel and its associated support structure. Generally, the wheel guard comprises a base portion attachable to the support structure between the support structure and the wheel and one or a pair of protrusions extending between the base portion and a contoured surface that substantially matches an axial face contour of the wheel.

The base portion and the protrusion may be integrally formed from a plastic material, rubber, or sheet metal. The base portion may also be contoured so that it follows a surface of the support structure. Preferably, the contoured surface is located within 5 mm of the axial face. The base portion may be attached to the support structure with fasteners that engage apertures formed through the base portion that are sized and configured to receive the fastener.

Also contemplated is a scooter incorporating wheel guards according to the disclosure. Such a scooter comprises a frame including opposed front and rear end portions with a deck extending along at least a majority of the frame. A steering assembly is pivotably disposed on the front end portion and a rear wheel is rotatably mounted on the rear end portion. The steering assembly includes a handlebar, a steering support structure, a front wheel rotatably mounted to the steering support structure, and a pair of front wheel guards interposed between the steering support structure and the front wheel. The steering support structure may be in the form of a fork comprising a pair of arms, wherein the front wheel guards are attached to the inner surface of each fork arm. In another embodiment, the wheel guards may be integral with the fork arms. Preferably, the scooter includes a pair of rear wheel guards interposed between a rear support structure and the axial face of the rear wheel.

Also disclosed herein is an improvement to a scooter that has an accessible axial clearance between one of its wheels and its chassis. The improvement comprises an insert means interposed between an axial face of the wheel and the chassis. The insert means is preferably configured as described herein to closely conform to the contour of the axial face of the wheel thereby reducing the clearance between the wheel and the chassis.

The foregoing and other features, utilities, and advantages of the wheel guard will be apparent from the following more particular description of the embodiments as illustrated in the accompanying drawings.

### BRIEF DESCRIPTION OF THE DRAWINGS

The accompanying drawings, which are incorporated in and constitute a part of this specification, illustrate multiple embodiments of a wheel guard insert and together with the description, serve to explain the principles thereof. Like items in the drawings are generally referred to using the same numerical reference.

FIG. 1 is a perspective view of a typical scooter;

FIG. 2 is a front view of a portion of the scooter steering assembly shown with the wheel in cross-section;

FIG. 3 is a front view of a portion of a scooter steering assembly similar to FIG. 3 including a pair of wheel guards;

FIGS. 4a and 4b are perspective views of a wheel guard according to a first exemplary embodiment;

FIGS. 5a and 5b are perspective views of a wheel guard according to a second exemplary embodiment; and

FIG. 6 is a front view of a portion of a scooter steering assembly according to a third exemplary embodiment shown with the wheel in cross-section.

### DETAILED DESCRIPTION

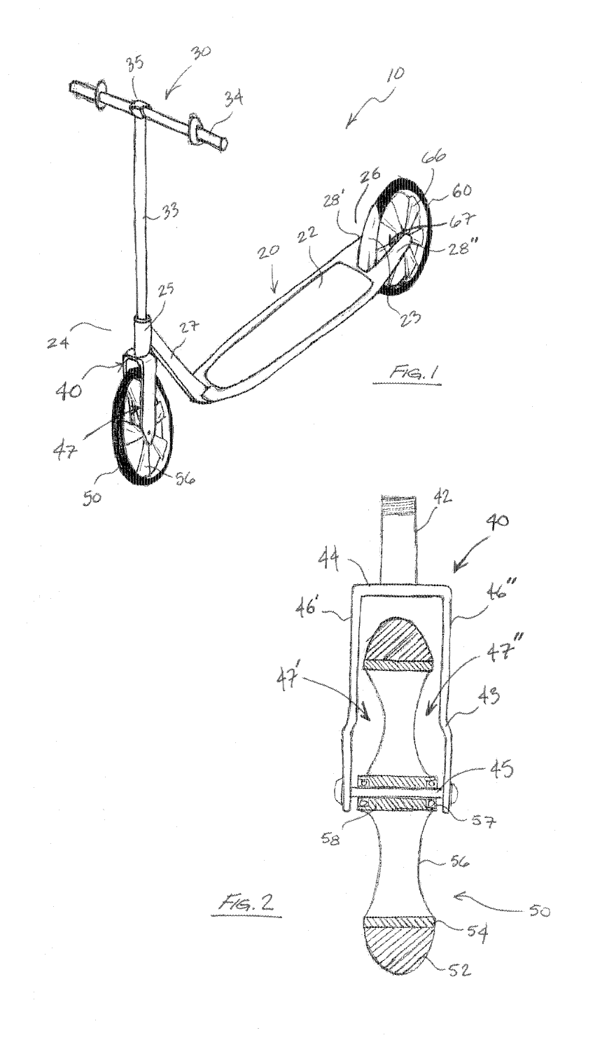

The following disclosure describes various embodiments of a wheel guard insert for use in reducing the axial gap between a wheel and its associated support structure. FIG. 1 illustrates a typical two wheeled scooter 10. Scooter 10 includes frame 20, steering assembly 30, and front and rear wheels, 50 and 60 respectively. Preferably the scooter includes a deck 22 that extends along frame 20 and provides a platform on which a rider may stand. The rear end portion 26 of the frame 20 includes support structures 28′ and 28″, which support rear wheel 60. As shown in the figure, rear end portion 26 may also include a fender 23. The frame and steering assembly together comprise a chassis of the scooter.

Frame 20 includes opposed front and rear end portions, 24 and 26 respectively. Front end portion 24 includes gooseneck 27 and a head tube 25 supported thereon. The steering assembly 30 is pivotably disposed on front end portion 24. Specifically, steering assembly 30 extends through head tube 25 which provides a bearing for the steering assembly to pivot. Steering assembly 30 includes a steering support structure 40, otherwise known as a front fork, a stem 33, and handlebars 34. Handlebars 34 are attached to stem 33 with a clamp 35 as is known in the art.

With further reference to FIG. 2, it can be appreciated that steering support structure 40 includes steering tube 42 which extends through head tube 25 and connects with stem 33. Transverse support member 44 is attached to steering tube 42 such that turning input from handlebar 34 is transferred to the steering support structure 40. Extending downwardly from transverse support member 44 are a pair of arms 46′ and 46″. Arms 46′ and 46″ support front wheel 50 via axle 45. Each support arm 46′ and 46″ may also include a contoured surface 43 that provides, for example, wheel hub clearance.

Wheel 50 includes a tire portion 52 which extends around rim 54. Rim 54 is supported by a plurality of spokes 56 which extend radially from hub 58. Preferably, hub 58 houses a pair of bearings 57 for providing a durable rotational attachment of the front wheel to front fork 40. As can be appreciated with reference to the figure, axial gaps 47′ and 47″ exist between the axial faces of wheel 50 and the inside of support arms 46′ and 46″. Referring once again to FIG. 1, it can be appreciated that similar axial gaps 67 exist between rear support structures 28′, 28″, and wheel spokes 66. It should be understood that gaps 67 and 47 may present potential pinch, crush, and/or trapping points for a rider's appendages.

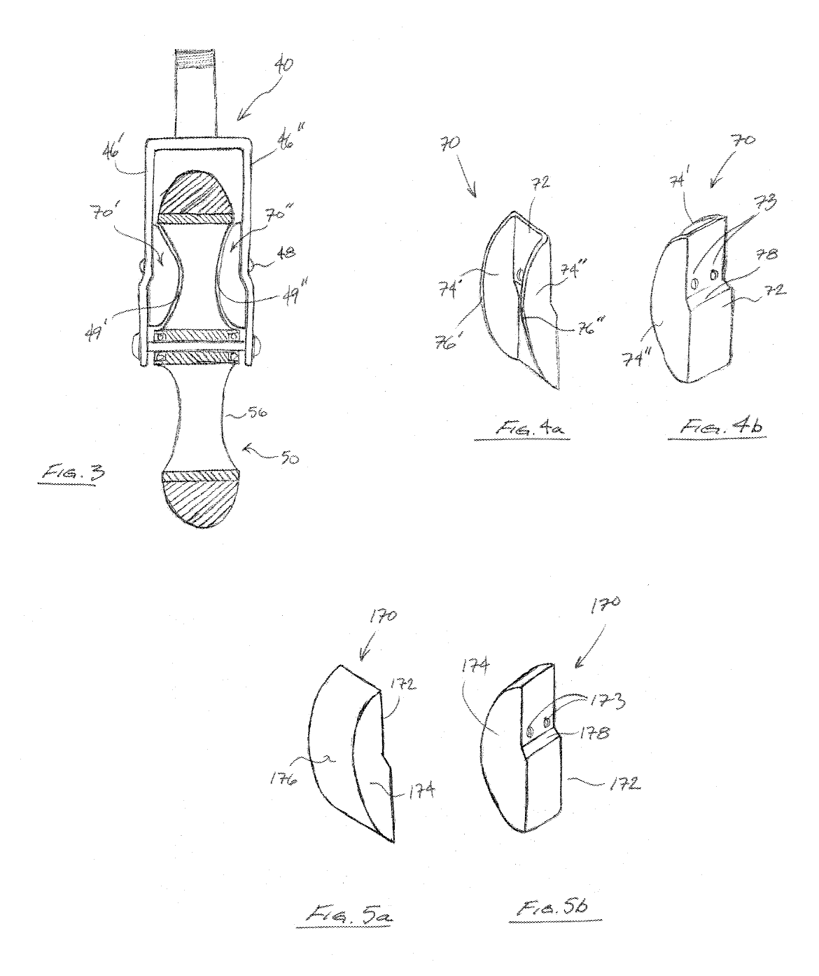

FIG. 3 illustrates steering support structure 40 and front wheel 50 including a pair of wheel guard inserts 70′ and 70″ according to the first exemplary embodiment. As can be appreciated from the figure, wheel guards 70′ and 70″ are interposed between the inside surfaces of arms 46′ and 46″ and the contoured axial face of wheel 50 (i.e., spokes 56). Thus, axial gaps 47′ and 47″ between wheel 50 and associated support structure 40 are eliminated or substantially reduced thereby preventing a rider's fingers and/or toes from entering the gap and being potentially injured. The resulting gaps 49′ and 49″ between the inserts 70 and the contoured axial faces of wheel 50 are preferably less than about 5 mm along the contoured axial face, and preferably satisfy, for example, the applicable safety standards associated with ASTM F2264.

Referring to FIGS. 4a and 4b, wheel guard insert 70 is shown to include a base portion 72 with a pair of protrusions 74′ and 74″ extending therefrom. In this case, protrusions 74′ and 74″ extend orthogonally from base portion 72 and each includes a contoured surface 76′ and 76″, respectively. Contoured surfaces 76′ and 76″ are configured to match the axial face contour of wheel 50, such as spokes 56. One of ordinary skill in the art will recognize that the axial faces of wheel 50, for instance, may be comprised of the outwardly, or axially, facing contoured surfaces of spoke 56 as well as the axial facing surfaces of rim 54 and the axial facing surfaces of hub 58, or any combination thereof. Furthermore, the contour of spoke 56 presented in the figures is merely an example and other contours are contemplated. Also, it should be appreciated that the wheel is not required to have spokes at all. The spaces between the spokes could be eliminated such that the rim is supported from the hub by a disk.

Base portion 72 may optionally include a contoured surface 78 which matches the contoured portion 43 of steering support arms 46. Contours 43 represented on support arms 46 are exemplary in nature and other contours are contemplated, including but not limited to, no contour at all. As shown in FIG. 4b, wheel guard insert 70 also includes one or more apertures 73 formed therethrough. Apertures 73 are sized and configured to receive a fastener 48, for example (see FIG. 3). For example, apertures 73 may be threaded holes for receiving a threaded screw. Thus, the wheel guard inserts may be attached to the arms of fork 40 after the wheel is installed on support structure 40. In this embodiment, it is contemplated that wheel guard insert 70 is formed of sheet metal which is bent into a U-shape. However, wheel insert 70 may be comprised of other suitable materials such as rubber or plastic, for example. Moreover, the base portion could be formed of a metal portion while the projections 74 are formed of a more resilient material such as plastic or rubber, for instance. It should also be appreciated from the figures that the wheel guard inserts 70 are reversible such that they may be used on either side of the front fork.

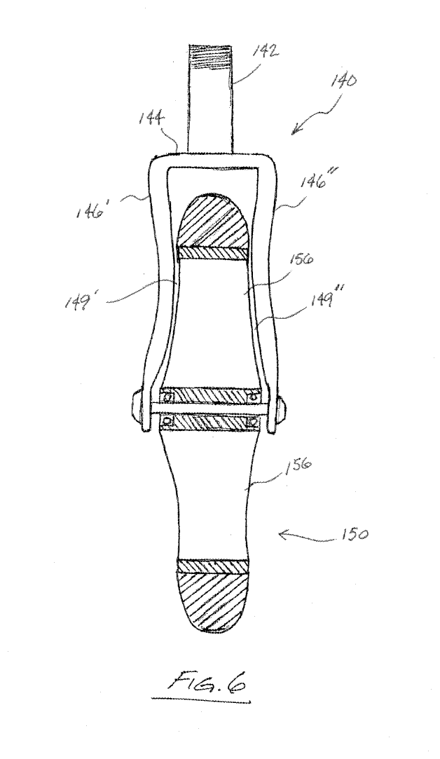

FIGS. 5a and 5b illustrate a second exemplary embodiment of the wheel guard insert 170. In this embodiment wheel guard insert 170 includes a base portion 172 with a protrusion 174 extending therefrom. Protrusion 174 includes a contoured surface 176 which corresponds with, or matches, the axial face contour of wheel 50. As perhaps best shown in FIG. 5b, base portion 172 may include a contoured surface 178 which matches a contour of support arms 46. Apertures 173 may be formed in the wheel guard insert 170 so that the insert may be attached to the support structure. In this embodiment, wheel guard insert 170 may be integrally formed from a unitary piece of material such as metal, plastic, or foam. For example, the insert 170 could be machined or cast from aluminum, steel, or the like. Alternatively, wheel insert 170 could be molded or cast from rubber or plastic, for example. In this construction, apertures 173 could be in the form of threaded inserts that are molded into the wheel guard insert. Base portion 172 could also be a metal plate having threaded apertures with a rubber or plastic protrusion cast or molded thereto.

In a third exemplary embodiment, the wheel guards are integral with the support arms as a means to reduce the gap between the wheel and the chassis. As shown in FIG. 6, steering support structure 140 includes steering tube 142 and transverse support member 144 is attached thereto. Extending downwardly from transverse support member 144 is a pair of arms 146′ and 146″. Arms 146′ and 146″ are shaped or bent along a contour which corresponds with, or matches, the axial face contour of wheel 150 (i.e. spokes 156). Thus, the resulting gaps 149′ and 149″ between arms 146′, 146″ and the axial face contours of wheel 150 are preferably less than about 5 mm along the face, and preferably satisfy, for example, the applicable safety standards associated with ASTM F2264.

While the various embodiments of the wheel guard insert whether separate or integrated have been described with respect to a steering support structure, such as a fork, the concepts and principles described herein apply equally to the rear end portion support structure of a scooter. Moreover, it is contemplated that the wheel guard inserts described herein could be applied to various vehicles where accessible clearances between movable segments exist. Examples of such vehicles might include bicycles, tricycles, and other wheel vehicles.

Accordingly, the wheel guard insert has been described with some degree of particularity directed to the exemplary embodiments. It should be appreciated, though, that the present invention is defined by the following claims construed in light of the prior art so that modifications or changes may be made to the exemplary embodiments without departing from the inventive concepts contained herein.

What is claimed is:

1. A wheel guard for use in reducing the axial gap between a wheel and its associated support structure, comprising:
A. a base portion attachable to the support structure between the support structure and the wheel; and
B. at least one protrusion extending between said base portion and a contoured surface that substantially matches an axial face contour of the wheel.

2. A wheel guard according to claim 1, wherein said base portion and said at least one protrusion are integrally formed from a plastic material.

3. A wheel guard according to claim 1, wherein said at least one protrusion is formed from a rubber material.

4. A wheel guard according to claim 1, wherein said base portion is contoured to follow a surface of the support structure.

5. A wheel guard according to claim 1, wherein said contoured surface is located within 5 mm of the axial face.

6. A wheel guard according to claim 1, including a pair of protrusions.

7. A wheel guard according to claim 6, wherein said pair of protrusions are integrally formed with said base portion.

8. A wheel guard according to claim 7, wherein said pair of protrusions and said base portion are comprised of sheet metal.

9. A wheel guard according to claim 8, further comprising an aperture formed through said base portion that is sized and configured to receive a fastener.

10. A scooter, comprising:
A. a frame including opposed front and rear end portions;
B. a deck extending along at least a majority of said frame;
C. a steering assembly pivotably disposed on said front end portion, said steering assembly including:
i. a steering support structure,
ii. a front wheel rotatably mounted to said steering support structure,
iii. a pair of front wheel guards interposed between said steering support structure and said front wheel, each said front wheel guard comprising:
(a) a base portion attached to said steering support structure, and
(b) at least one protrusion extending between said base portion and a contoured surface that substantially matches an axial face contour of said front wheel, and
iv. a handlebar connected to said steering support structure; and
D. a rear wheel rotatably mounted on said rear end portion.

11. A scooter according to claim 10, including a pair of rear wheel guards interposed between a rear support structure and said axial face of said rear wheel.

12. A scooter according to claim 10, wherein said base portion and said at least one protrusion are integrally formed from a plastic material.

13. A scooter according to claim 10, wherein said at least one protrusion is formed from a rubber material.

14. A scooter according to claim 10, wherein each said front wheel guard includes a pair of protrusions.

15. A scooter according to claim 14, wherein said pair of protrusions are integrally formed with said base portion.

16. A scooter according to claim 15, wherein said pair of protrusions and said base portion are comprised of sheet metal.

17. A scooter according to claim 16, further comprising an aperture formed through said base portion that is sized and configured to receive a fastener.

18. A scooter according to claim 10, wherein said steering support structure is in the form of a fork comprising a pair of arms.

19. A scooter according to claim 18, wherein said front wheel guards are attached to the inner surface of each fork arm.

20. In a scooter having accessible axial clearance between a wheel of the scooter and its associated chassis, the improvement comprising:
an insert means interposed between an axial face of the wheel and the chassis, said insert means configured to closely conform to the contour of the axial face thereby reducing the clearance between the wheel and the chassis.
